(19) United States
(12) Patent Application Publication
(10) Pub. No.: US 2025/0150810 A1
(43) Pub. Date: May 8, 2025

(54) TERMINAL CAPABILITY TRANSMISSION METHOD AND APPARATUS, AND READABLE STORAGE MEDIUM

(71) Applicant: Beijing Xiaomi Mobile Software Co., Ltd., Beijing (CN)

(72) Inventor: Juan ZHANG, Beijing (CN)

(73) Assignee: Beijing Xiaomi Mobile Software Co., Ltd., Beijing (CN)

(21) Appl. No.: 18/837,970

(22) PCT Filed: Feb. 14, 2022
(86) PCT No.: PCT/CN2022/076247

§ 371 Date: Aug. 13, 2024

(51) Int. Cl. H04W 8/24; H04W 72/044

(52) U.S. Cl. CPC H04W 8/24; H04W 72/044

(57) ABSTRACT

The present disclosure provides a terminal capability transmission method and apparatus, and a readable storage medium, which are applied to the technical field of wireless communications. The method includes sending to a network device a first capability for indicating carrier aggregation between supported frequency bands, and first information for indicating a coverage range of an aggregation spectrum.

### CROSS-REFERENCE TO RELATED APPLICATIONS

The present application is a U.S. National Stage of International Application No. PCT/CN2022/076247, filed on Feb. 14, 2022, the contents of which are incorporated herein by reference in its entirety for all purposes.

### TECHNICAL FIELD

The present disclosure relates to the field of wireless communication technologies, and in particular to a method and apparatus for transmitting a terminal capability, and a readable storage medium.

### BACKGROUND

With the development of wireless communication technologies, Carrier Aggregation (CA) technologies have been introduced, which can aggregate a plurality of Component Carriers (CCs) together to achieve a relatively large transmission bandwidth.

In the wireless communication technologies, for example, in the fifth generation (5G) communication technologies, intra-band carrier aggregation and inter-band carrier aggregation are included in multi-carrier systems in a millimeter wave band.

### SUMMARY

The present disclosure provides a method and apparatus for transmitting a terminal capability, and a readable storage medium.

In a first aspect, there is provided a method for transmitting a terminal capability, which is performed by a user equipment. The method includes:

sending, to a network device, a first capability for indicating support for inter-band carrier aggregation and first information for indicating coverage of an aggregated spectrum.

In a second aspect, there is provided a method for receiving a terminal capability, which is performed by a network device. The method includes:

receiving a first capability for indicating support for inter-band carrier aggregation and first information for indicating coverage of an aggregated spectrum that are sent by a user equipment.

In a third aspect, there is provided a communication device, including a processor and a memory; the memory is configured to store a computer program; and the processor is configured to perform the computer program to implement the first aspect or any possible design thereof.

In a fourth aspect, there is provided a communication device, including a processor and a memory; the memory is configured to store a computer program; the processor is configured to perform the computer program to implement the second aspect or any possible design thereof.

It is to be understood that the foregoing general description and the following detailed description are exemplary and explanatory only and are not restrictive of the present disclosure.

### BRIEF DESCRIPTION OF THE DRAWINGS

The accompanying drawings described herein are used to provide a further understanding of embodiments of the present disclosure, and constitute a part of the present disclosure. The illustrative examples and descriptions of embodiments of the present disclosure are used to explain the embodiments of the present disclosure without constituting any improper limitations on the embodiments of the present disclosure.

FIG. 1 is a schematic diagram of a wireless communication system architecture provided by an embodiment of the present disclosure;

FIG. 2 is a flowchart showing a method for transmitting a terminal capability according to an embodiment of the present disclosure;

FIG. 3 is a flowchart showing a method for transmitting a terminal capability according to an embodiment of the present disclosure;

FIG. 4 is a flowchart showing a method for transmitting a terminal capability according to an embodiment of the present disclosure;

FIG. 5 is a flowchart showing a method for transmitting a terminal capability according to an embodiment of the present disclosure;

FIG. 6 is a flowchart showing a method for transmitting a terminal capability according to an embodiment of the present disclosure;

FIG. 7 is a flowchart showing a method for transmitting a terminal capability according to an embodiment of the present disclosure;

FIG. 8 is a flowchart showing a method for transmitting a terminal capability according to an embodiment of the present disclosure;

FIG. 9 is a flowchart showing a method for transmitting a terminal capability according to an embodiment of the present disclosure;

FIG. 10 is a structural diagram showing an apparatus for transmitting a terminal capability according to an embodiment of the present disclosure;

FIG. 11 is a structural diagram showing an apparatus for transmitting a terminal capability according to an embodiment of the present disclosure;

FIG. 12 is a structural diagram showing an apparatus for transmitting a terminal capability according to an embodiment of the present disclosure; and

FIG. 13 is a structural diagram showing an apparatus for transmitting a terminal capability according to an embodiment of the present disclosure.

### DETAILED DESCRIPTION

Embodiments of the present disclosure will now be further described with reference to the accompanying drawings and specific implementations.

Exemplary embodiments will be described in detail herein, examples of which are illustrated in the accompanying drawings. Where the following description refers to the drawings, the same numerals in different drawings refer to the same or similar elements unless otherwise indicated. The implementations described in the following exemplary embodiments are not intended to represent all implementations consistent with the disclosed embodiments. Rather, they are merely examples of apparatus and methods consistent with some aspects of the present disclosure as defined in the appended claims.

The terms used in embodiments of the present disclosure are merely for the purpose of describing particular embodiments and are not intended to limit the embodiments of the present disclosure. As used in the embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that although the terms first, second, third, etc. may be used in embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “upon” or “when” or “in response to determination”.

Embodiments of the present disclosure are described in detail below, examples of which are shown in the accompanying drawings, where the same or similar reference numerals throughout represent the same or similar elements. The embodiments described below with reference to the accompanying drawings are illustrative and are intended to explain the present disclosure, and should not be construed as limiting the present disclosure.

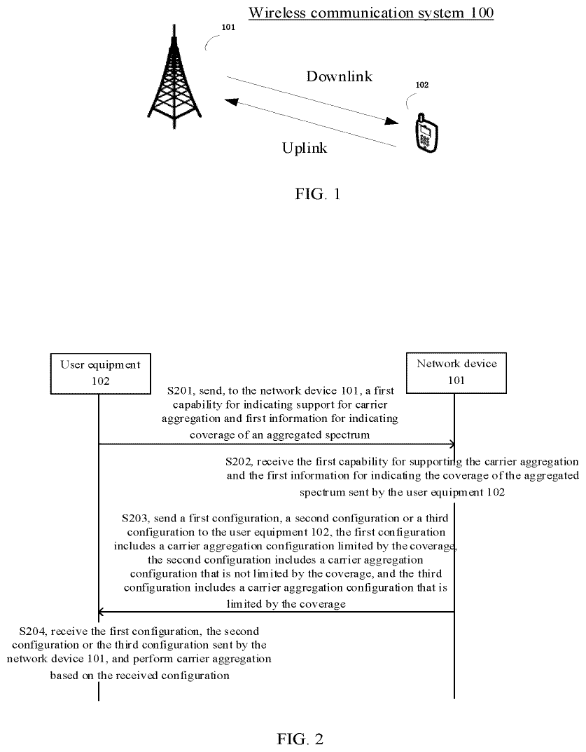

As shown in FIG. 1, a method for transmitting a terminal capability provided by embodiments of the present disclosure may be applied to a wireless communication system 100, which may include, but is not limited to, a network device 101 and a user equipment 102. The user equipment 102 is configured to support carrier aggregation, and the user equipment 102 may be connected to a plurality of carrier units of the network device 101, including one primary carrier unit and one or more secondary carrier units.

It should be understood that the above wireless communication system 100 is applicable to both low frequency scenarios and high frequency scenarios. Application scenarios of the wireless communication system 100 include, but are not limited to, long term evolution (LTE) system, LTE frequency division duplex (FDD) system, LTE time division duplex (TDD) system, worldwide interoperability for microwave access (WiMAX) communication system, cloud radio access network (CRAN) system, future 5th-Generation (5G) system, new radio (NR) communication system, future-evolved public land mobile network (PLMN) system, or the like.

The user equipment 102 described above may be a user equipment (UE), a terminal, an access terminal, a terminal unit, a terminal station, a mobile station (MS), a remote station, a remote terminal, a mobile terminal, a wireless communication device, a terminal agent, a user device, or the like. The user equipment 102 may have a wireless transceiver function, which can perform communication (e.g., wireless communication) with one or more network devices 101 of one or more communication systems, and accept network services provided by the network device 101, where the network device 101 includes, but is not limited to, the base station as illustrated.

The user equipment 102 may be a cellular phone, a cordless phone, a session initiation protocol (SIP) phone, a wireless local loop (WLL) station, a personal digital assistant (PDA) device, a handheld device with wireless communication functions, a computing device or another processing device connected to wireless modems, an in-vehicle device, a wearable device, a user device in future 5G networks, a user device in future-evolved PLMN networks, or the like.

The network devices 101 may be an access network device (or an access network station). The access network device refers to a device that provides a network access function, such as a radio access network (RAN) base station, and the like. The network devices may specifically include a base station (BS), or include a base station and a radio resource management device for controlling the base station, and the like. The network devices may also include a relay station (relay device), an access point, a base station in a future 5G network, a base station in a future-evolved PLMN network, an NR base station, or the like. The network devices may be a wearable device or a vehicle-mounted device. The network devices may also be a communication chip with a communication module.

For example, the network device 101 includes, but is not limited to, a next-generation base station (gnodeB, gNB) in 5G, an evolved node B (eNB) in the LTE system, a radio network controller (RNC), a Node B (NB) in WCDMA system, a wireless controller in CRAN system, a base station controller (BSC), a base transceiver station (BTS) in GSM system or CDMA system, a home base station (e.g., home evolved nodeB; or home node B, HNB), a baseband unit (BBU), a transmitting and receiving point (TRP), a transmitting point (TP), mobile switching center, or the like.

As described above, with the development of wireless communication technologies, Carrier Aggregation (CA) technologies have been introduced, which can aggregate a plurality of Component Carriers (CCs) together to achieve a relatively large transmission bandwidth.

In the wireless communication technologies, for example, in the fifth generation (5G) communication technologies, intra-band carrier aggregation and inter-band carrier aggregation are included in multi-carrier systems in a millimeter wave band.

For the inter-band carrier aggregation in the multi-carrier systems, User Equipment (UE) may share a radio frequency channel between two or more bands. When the UE shares the radio frequency channel between the two or more bands, the carrier aggregation between these bands can only be supported within a certain spectrum range due to device performance limitations. In a case where the UE cannot support the carrier aggregation in the entire aggregated band, when a network device configures the carrier aggregation for the UE on a band that exceeds a UE's hardware performance range, the UE will not be able to support this configuration, resulting in a failure of the carrier aggregation connection.

Embodiments of the present disclosure provide a method for transmitting a terminal capability. FIG. 2 is a flowchart showing a method for transmitting a terminal capability according to an embodiment of the present disclosure. As shown in FIG. 2, the method includes steps S201 to S204.

In the step S201, the user equipment 102 sends, to the network device 101, a first capability for indicating support for inter-band carrier aggregation and first information for indicating coverage of an aggregated spectrum.

In the step S202, the network device 101 receives the first capability for indicating the support for the inter-band carrier aggregation and the first information for indicating the coverage of the aggregated spectrum sent by the user equipment 102.

In the step S203, the network device sends a first configuration, a second configuration or a third configuration to the user equipment, the first configuration includes a carrier aggregation configuration limited by the coverage, the second configuration includes a carrier aggregation configuration that is not limited by the coverage, and the third configuration includes a carrier aggregation configuration that is limited by the coverage. In an example, the first configuration and the third configuration are the same.

In the step S204, the user equipment 102 receives the first configuration, the second configuration or the third configuration sent by the network device 101, and performs carrier aggregation based on the received configuration.

In some implementations, the first capability for indicating the support for the inter-band carrier aggregation is sent through a first signaling or a second signaling in the step S201, the first signaling is a signaling used to send a second type of radio frequency link supporting multi-carrier aggregation, the second type corresponds to a single-link type, and the second signaling is a signaling used to send the support for highPSD.

In some implementations, the first information for indicating the coverage of the aggregated spectrum is sent through an FS_inter signaling in the step S201.

In some implementations, in the step S201, the user equipment 102 simultaneously sends, to the network device 101, the first capability for indicating the support for the inter-band carrier aggregation and the first information for indicating the coverage of the aggregated spectrum. In an example, the first capability for indicating the support for the inter-band carrier aggregation and the first information for indicating the coverage of the aggregated spectrum are simultaneously sent through the FS_inter signaling in the step S201.

In embodiments of the present disclosure, the user equipment sends to the network device the first information for indicating the coverage of the aggregated spectrum, so that the network device is clearly aware of the coverage of the aggregated spectrum that the user equipment can support, providing a condition for the network device to set a carrier aggregation configuration for the user equipment that meets a capability of the user equipment, so as to prevent the carrier aggregation connection failure.

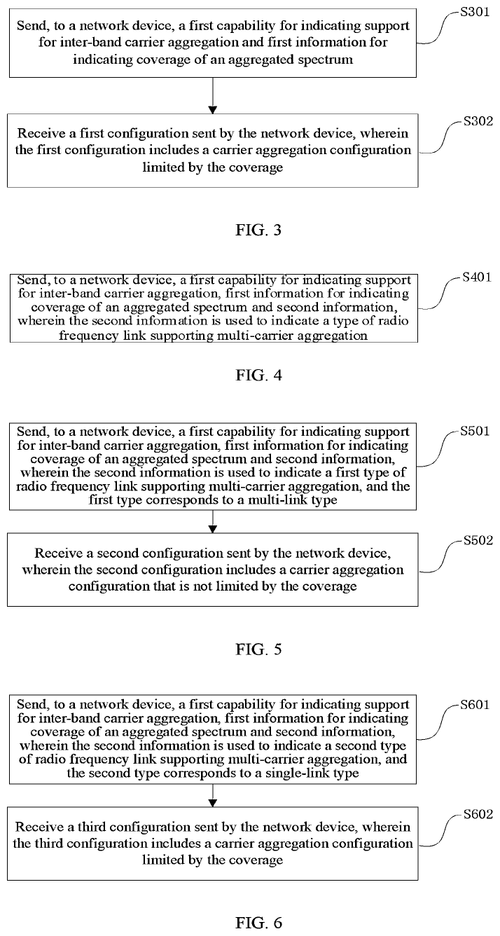

Embodiments of the present disclosure provide a method for sending a terminal capability, which is performed by a user equipment. The method can be executed alone or in combination with any other embodiment of the present disclosure. FIG. 3 is a flowchart showing a method for sending a terminal capability according to an embodiment of the present disclosure. As shown in FIG. 3, the method includes:

in step S301, a first capability for indicating support for inter-band carrier aggregation and first information for indicating coverage of an aggregated spectrum are sent to a network device.

In some implementations, the first capability for indicating the support for the inter-band carrier aggregation is sent through a first signaling or a second signaling in the step S301, the first signaling is a signaling used to send a second type of radio frequency link supporting multi-carrier aggregation, the second type corresponds to a single-link type, and the second signaling is a signaling used to send the support for highPSD.

In some implementations, the first information for indicating the coverage of the aggregated spectrum is sent through an FS_inter signaling in the step S301.

In some implementations, in the step S301, the user equipment 102 simultaneously sends, to the network device 101, the first capability for indicating the support for the inter-band carrier aggregation and the first information for indicating the coverage of the aggregated spectrum.

In an example, the first capability for indicating the support for the inter-band carrier aggregation and the first information for indicating the coverage of the aggregated spectrum are simultaneously sent through the FS_inter signaling in the step S301.

Using the same signaling to simultaneously send the first capability for indicating the support for the inter-band carrier aggregation and the first information for indicating the coverage of the aggregated spectrum can save the signaling and wireless resources compared to the use of different signalings for sending.

In some implementations, the method further includes: in step S302, a first configuration sent by the network device is received, and the first configuration includes a carrier aggregation configuration limited by the coverage.

In some implementations, the user equipment is applied to a multi-carrier system, and the multi-carrier system includes Carrier Aggregation (CA) and Dual Connectivity (DC). The dual connectivity is one of:
New Radio Dual Connectivity (NR DC),
E-UTRA-NR Dual Connectivity (EN-DC),
NR-E-UTRA Dual Connectivity (NE-DC), or
NG-RAN E-UTRA-NR Dual Connectivity (NGEN-DC).

NR DC refers to the dual connectivity in the new radio, EN-DC refers to the dual connectivity between the 4G wireless access network and the 5G NR, NE-DC refers to the dual connectivity between the 5G NR and the 4G wireless access network, and NGEN-DC refers to the dual connectivity between the 4G wireless access network in the 5G core network and the 5G NR.

In embodiments of the present disclosure, the user equipment sends to the network device the first information for indicating the coverage of the aggregated spectrum, so that the network device is clearly aware of the coverage of the aggregated spectrum that the user equipment can support, providing a condition for the network device to set a carrier aggregation configuration for the user equipment that meets a capability of the user equipment, so as to prevent the carrier aggregation connection failure.

Embodiments of the present disclosure provide a method for sending a terminal capability, which is performed by a user equipment. The method can be executed alone or in combination with any other embodiment of the present disclosure. FIG. 4 is a flowchart showing a method for sending a terminal capability according to an embodiment of the present disclosure. As shown in FIG. 4, the method includes:

in step S401, a first capability for indicating support for inter-band carrier aggregation, first information for indicating coverage of an aggregated spectrum, and second information are sent to a network device, and the second information is used to indicate a type of radio frequency link supporting multi-carrier aggregation.

In some implementations, in the step S401, the first capability for indicating the support for the inter-band carrier aggregation, the first information for indicating the coverage of the aggregated spectrum, and the second information are simultaneously sent to the network device.

In some implementations, a configuration determined by the network device based on the first capability, the first information, and the second information is received.

In some implementations, the user equipment is applied to a multi-carrier system, the multi-carrier system includes Carrier Aggregation (CA) and Dual Connectivity (DC), and the dual connectivity is one of: NR DC, EN-DC, NE-DC, or NGNE-DC.

In embodiments of the present disclosure, the user equipment sends the second information to the network device, and the second information is used to indicate the type of radio frequency link supporting the multi-carrier aggregation. The type of radio frequency link supporting the multi-carrier aggregation in the communication process is provided, so that the network device sets a more reasonable multi-carrier aggregation configuration for the user equipment based on the type of radio frequency link.

Embodiments of the present disclosure provide a method for sending a terminal capability, which is performed by a user equipment. The method can be executed alone or in combination with any other embodiment of the present disclosure. FIG. 5 is a flowchart showing a method for sending a terminal capability according to an embodiment of the present disclosure. As shown in FIG. 5, the method includes:

in step S501, a first capability for indicating support for inter-band carrier aggregation, first information for indicating coverage of an aggregated spectrum, and second information are sent to a network device, and the second information is used to indicate a first type of radio frequency link supporting multi-carrier aggregation, and the first type corresponds to a multi-link type; and

in step S502, a second configuration sent by the network device is received, and the second configuration includes a carrier aggregation configuration that is not limited by the coverage.

In some implementations, the user equipment is applied to a multi-carrier system, the multi-carrier system includes Carrier Aggregation (CA) and Dual Connectivity (DC), and the dual connectivity is one of: NR DC, EN-DC, NE-DC, or NGNE-DC.

In embodiments of the present disclosure, the user equipment sends to the network device the second information indicating the multi-link type of radio frequency link supporting the multi-carrier aggregation, and receives the second configuration sent by the network device, the second configuration includes the carrier aggregation configuration that is not limited by the coverage.

Embodiments of the present disclosure provide a method for sending a terminal capability, which is performed by a user equipment. The method can be executed alone or in combination with any other embodiment of the present disclosure. FIG. 6 is a flowchart showing a method for sending a terminal capability according to an embodiment of the present disclosure. As shown in FIG. 6, the method includes:

in step S601, a first capability for indicating support for inter-band carrier aggregation, first information for indicating coverage of an aggregated spectrum, and second information are sent to a network device, and the second information is used to indicate a second type of radio frequency link supporting multi-carrier aggregation, and the second type corresponds to a single-link type; and

in step S602, a third configuration sent by the network device is received, and the third configuration includes a carrier aggregation configuration limited by the coverage.

In some implementations, the user equipment is applied to a multi-carrier system, the multi-carrier system includes Carrier Aggregation (CA) and Dual Connectivity (DC), and the dual connectivity is one of: NR DC, EN-DC, NE-DC, or NGNE-DC.

In embodiments of the present disclosure, the user equipment sends to the network device the second information indicating the single-link type of radio frequency link supporting the multi-carrier aggregation, and receives the third configuration sent by the network device, the third configuration includes the carrier aggregation configuration limited by the coverage.

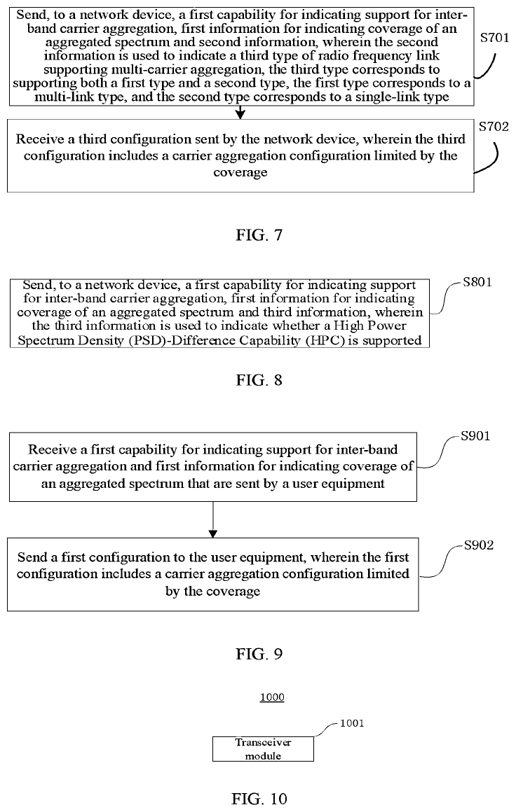

Embodiments of the present disclosure provide a method for sending a terminal capability, which is performed by a user equipment. The method can be executed alone or in combination with any other embodiment of the present disclosure. FIG. 7 is a flowchart showing a method for sending a terminal capability according to an embodiment of the present disclosure. As shown in FIG. 7, the method includes:

in step S701, a first capability for indicating support for inter-band carrier aggregation, first information for indicating coverage of an aggregated spectrum, and second information are sent to a network device, and the second information is used to indicate a third type of radio frequency link supporting multi-carrier aggregation, the third type corresponds to supporting both a first type and a second type, the first type corresponds to a multi-link type, and the second type corresponds to a single-link type; and in step S702, a third configuration sent by the network device is received, and the third configuration includes a carrier aggregation configuration limited by the coverage.

In some implementations, the user equipment is applied to a multi-carrier system, the multi-carrier system includes Carrier Aggregation (CA) and Dual Connectivity (DC), and the dual connectivity is one of: NR DC, EN-DC, NE-DC, or NGNE-DC.

In embodiments of the present disclosure, the user equipment sends to the network device the second information indicating the single-link type of radio frequency link and the multi-link type of radio frequency link that both support the multi-carrier aggregation, and receives the third configuration sent by the network device, the third configuration includes the carrier aggregation configuration limited by the coverage.

Embodiments of the present disclosure provide a method for sending a terminal capability, which is performed by a user equipment. The method can be executed alone or in combination with any other embodiment of the present disclosure. FIG. 8 is a flowchart showing a method for sending a terminal capability according to an embodiment of the present disclosure. As shown in FIG. 8, the method includes:

in step S801, a first capability for indicating support for inter-band carrier aggregation, first information for indicating coverage of an aggregated spectrum, and third information are sent to a network device, and the third information is used to indicate whether a High Power Spectrum Density (PSD)-Difference Capability (HPC) between different carriers is supported.

In some implementations, sending the third information to the network device includes:
sending a first signaling (e.g., supportHPC) to the network device, and the first signaling corresponds to indicating support, or,
sending a second signaling to the network device, and the second signaling corresponds to indicating non-support, the first signaling is not included in the second signaling.

In some implementations, in response to the third information being used to indicate that the High Power Spectrum Density (PSD)-Difference Capability (HPC) between different carriers is not supported, a fourth configuration sent by the network device is received, and the fourth configuration includes a carrier aggregation configuration limited by the coverage.

In some implementations, in response to the third information being used to indicate that the High Power Spectrum Density (PSD)-Difference Capability (HPC) between different carriers is supported, a fifth configuration sent by the network device is received, and the fifth configuration includes a carrier aggregation configuration that is not limited by the coverage.

In some implementations, the user equipment is applied to a multi-carrier system, the multi-carrier system includes Carrier Aggregation (CA) and Dual Connectivity (DC), and the dual connectivity is one of: NR DC, EN-DC, NE-DC, or NGNE-DC.

In embodiments of the present disclosure, the user equipment sends the third information to the network device, and the third information is used to indicate whether a High Power Spectrum Density (PSD)-Difference Capability (HPC) between different carriers is supported, so that the network device sets a more reasonable multi-carrier aggregation configuration for the user equipment based on the third information.

Embodiments of the present disclosure provide a method for receiving a terminal capability, which is performed by a network device. The method can be executed alone or in combination with any other embodiment of the present disclosure. FIG. 9 is a flowchart showing a method for receiving a terminal capability according to an embodiment of the present disclosure. As shown in FIG. 9, the method includes:

in step S901, a first capability for indicating support for inter-band carrier aggregation and first information for indicating coverage of an aggregated spectrum that are sent by a user equipment are received.

In some implementations, in the step S901, the first capability for indicating the support for the inter-band carrier aggregation and the first information for indicating the coverage of the aggregated spectrum that are simultaneously sent by the user equipment are received.

In some implementations, the method further includes: in step S902, a first configuration is sent to the user equipment, and the first configuration includes a carrier aggregation configuration limited by the coverage.

In some implementations, the network device is applied to a multi-carrier system, the multi-carrier system includes Carrier Aggregation (CA) and Dual Connectivity (DC), and the dual connectivity is one of: NR DC, EN-DC, NE-DC, or NGNE-DC.

Embodiments of the present disclosure provide a method for receiving a terminal capability, which is performed by a network device. The method includes:

receiving a first capability for indicating support for inter-band carrier aggregation, first information for indicating coverage of an aggregated spectrum and second information that are sent by the user equipment, and the second information is used to indicate a type of radio frequency link supporting multi-carrier aggregation.

In some implementations, the first capability for indicating the support for the inter-band carrier aggregation, the first information for indicating the coverage of the aggregated spectrum and the second information that are simultaneously sent by the user equipment are received.

In some implementations, the network device is applied to a multi-carrier system, the multi-carrier system includes Carrier Aggregation (CA) and Dual Connectivity (DC), and the dual connectivity is one of: NR DC, EN-DC, NE-DC, or NGNE-DC.

Embodiments of the present disclosure provide a method for receiving a terminal capability, which is performed by a network device. The method includes:

receiving a first capability for indicating support for inter-band carrier aggregation, first information for indicating coverage of an aggregated spectrum and second information that are sent by the user equipment, and the second information is used to indicate a type of radio frequency link supporting multi-carrier aggregation.

In response to the type of radio frequency link supporting the multi-carrier aggregation being a first type, a second configuration is sent to the user equipment, the first type corresponds to a multi-link type, and the second configuration includes a carrier aggregation configuration that is not limited by the coverage.

In some implementations, the first capability for indicating the support for the inter-band carrier aggregation, the first information for indicating the coverage of the aggregated spectrum and the second information that are simultaneously sent by the user equipment are received.

In some implementations, the network device is applied to a multi-carrier system, the multi-carrier system includes Carrier Aggregation (CA) and Dual Connectivity (DC), and the dual connectivity is one of: NR DC, EN-DC, NE-DC, or NGNE-DC.

Embodiments of the present disclosure provide a method for receiving a terminal capability, which is performed by a network device. The method includes:

receiving a first capability for indicating support for inter-band carrier aggregation, first information for indicating coverage of an aggregated spectrum and second information that are sent by the user equipment, and the second information is used to indicate a type of radio frequency link supporting multi-carrier aggregation.

In response to the second information that the type of radio frequency link supporting the multi-carrier aggregation is the second type or the third type, a third configuration is sent to the user equipment, the second type corresponds to a single-link type, the third type corresponds to supporting both a first type and the second type, the first type corresponds to a multi-link type, and the third configuration includes a carrier aggregation configuration limited by the coverage.

In some implementations, the first capability for indicating the support for the inter-band carrier aggregation, the first information for indicating the coverage of the aggregated spectrum and the second information that are simultaneously sent by the user equipment are received.

In some implementations, the network device is applied to a multi-carrier system, the multi-carrier system includes Carrier Aggregation (CA) and Dual Connectivity (DC), and the dual connectivity is one of: NR DC, EN-DC, NE-DC, or NGNE-DC.

Embodiments of the present disclosure provide a method for receiving a terminal capability, which is performed by a network device. The method includes:

receiving a first capability for indicating support for inter-band carrier aggregation, first information for indicating coverage of an aggregated spectrum and third information that are sent by the user equipment, and the third information is used to indicate whether a High Power Spectrum Density (PSD)-Difference Capability (HPC) between different carriers is supported.

In some implementations, receiving the third information sent by user equipment includes:
receiving a first signaling (e.g., supportHPC) sent by the user equipment to determine that HPC is supported by the user equipment, or,
receiving a second signaling sent by the user equipment to determine that HPC is not supported by the user equipment, and the first signaling is not included in the second signaling.

In some implementations, in response to receiving the third information sent by the user equipment which indicates that High Power Spectrum Density (PSD)-Difference Capability (HPC) between different carriers is not supported, a fourth configuration is sent to the user equipment, and the fourth configuration includes a carrier aggregation configuration limited by the coverage.

In some implementations, in response to receiving the third information sent by the user equipment which indicates that High Power Spectrum Density (PSD)-Difference Capability (HPC) between different carriers is supported, a fifth configuration is sent to the user equipment, and the fifth configuration includes a carrier aggregation configuration that is not limited by the coverage.

In some implementations, the network device is applied to a multi-carrier system, the multi-carrier system includes Carrier Aggregation (CA) and Dual Connectivity (DC), and the dual connectivity is one of: NR DC, EN-DC, NE-DC, or NGNE-DC.

Based on the same concept as the above method embodiments, embodiments of the present disclosure further provide a communication device, which may have the functions of the user equipment 102 in the above method embodiments, and can be configured to perform steps performed by the user equipment 102 according to the above method embodiments. These functions may be implemented by hardware, or may be implemented by software or by hardware executing corresponding software. The hardware or software includes one or more modules corresponding to the above functions.

In an implementation, a communication device 1000 shown in FIG. 10 may serve as the user equipment 102 involved in the above method embodiments, and perform the steps performed by the user equipment 102 in one of the above method embodiments.

The communication device 1000 includes:
a transceiver module 1001, configured to send, to a network device, a first capability for indicating support for inter-band carrier aggregation and first information for indicating coverage of an aggregated spectrum.

In some implementations, the transceiver module 1001 is further configured to simultaneously send, to the network device, the first capability for indicating the support for the inter-band carrier aggregation and the first information for indicating the coverage of the aggregated spectrum.

In some implementations, the transceiver module 1001 is further configured to receive a first configuration sent by the network device, wherein the first configuration includes a carrier aggregation configuration limited by the coverage.

In some implementations, the transceiver module 1001 is further configured to send second information to the network device, wherein the second information is used to indicate a type of radio frequency link supporting multi-carrier aggregation.

In some implementations, the type of radio frequency link supporting the multi-carrier aggregation is a first type, and the first type corresponds to a multi-link type.

In some implementations, the transceiver module 1001 is further configured to receive a second configuration sent by the network device, wherein the second configuration includes a carrier aggregation configuration that is not limited by the coverage.

In some implementations, the type of radio frequency link supporting the multi-carrier aggregation is a second type, and the second type corresponds to a single-link type.

In some implementations, the type of radio frequency link supporting the multi-carrier aggregation is a third type, the third type corresponds to supporting both a first type and a second type, the first type corresponds to a multi-link type, and the second type corresponds to a single-link type.

In some implementations, the transceiver module 1001 is further configured to receive a third configuration sent by the network device, wherein the third configuration includes a carrier aggregation configuration limited by the coverage.

In some implementations, the transceiver module 1001 is further configured to send third information to the network device, wherein the third information is used to indicate whether a High Power Spectrum Density (PSD)-Difference Capability (HPC) between different carriers is supported.

In some implementations, the transceiver module 1001 is further configured to send a first signaling to the network device, wherein the first signaling corresponds to indicating support, or, send a second signaling to the network device, wherein the second signaling corresponds to indicating non-support, and the first signaling is not included in the second signaling.

In some implementations, the transceiver module 1001 is further configured to, in response to the third information indicating that the High Power Spectrum Density (PSD)-Difference Capability (HPC) between different carriers is not supported, receive a fourth configuration sent by the network device, wherein the fourth configuration includes a carrier aggregation configuration limited by the coverage.

In some implementations, the transceiver module 1001 is further configured to, in response to the third information indicating that the High Power Spectrum Density (PSD)-Difference Capability (HPC) between different carriers is supported, receive a fifth configuration sent by the network device, wherein the fifth configuration includes a carrier aggregation configuration that is not limited by the coverage.

In some implementations, the user equipment is applied to a multi-carrier system, wherein the multi-carrier system includes Carrier Aggregation (CA) and Dual Connectivity (DC), and the dual connectivity is one of: NR DC, EN-DC, NE-DC, or NGNE-DC.

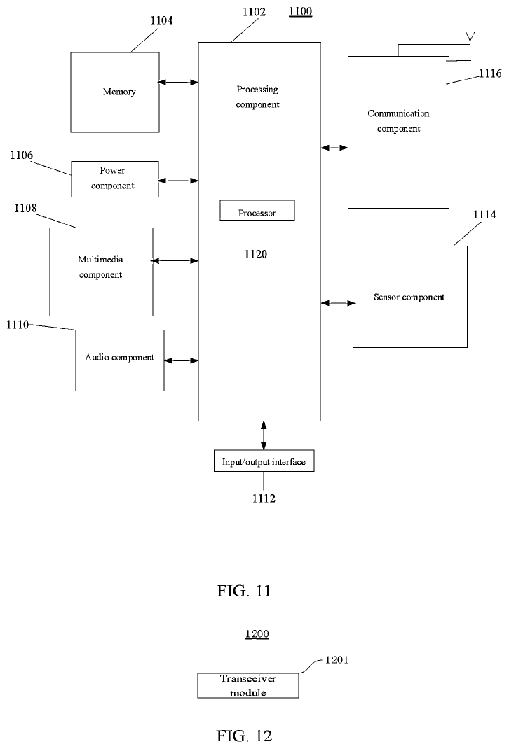

When the communication device is the user equipment, its structure may also be as shown in FIG. 11. FIG. 11 is a block diagram showing an apparatus 1100 for sending a terminal capability according to an embodiment of the present disclosure. For example, the apparatus 1100 may be a mobile phone, a computer, a digital broadcast terminal, a messaging device, a gaming console, a tablet device, a medical device, an exercise device, a personal digital assistant, etc.

Referring to FIG. 11, the apparatus 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the apparatus 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the apparatus 1100. Examples of such data include instructions for any applications or methods operated on the apparatus 1100, contact data, phonebook data, messages, pictures, video, etc. The memory 1104 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the apparatus 1100. The power component 1106 may include a power management system, one or more power sources, and any other components associated with the generation, management, and distribution of power in the apparatus 1100.

The multimedia component 1108 includes a screen providing an output interface between the apparatus 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 1108 includes a front camera and/or a rear camera. The front camera and the rear camera may receive an external multimedia datum while the apparatus 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (MIC) configured to receive an external audio signal when the apparatus 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide state assessments of various aspects of the apparatus 1100. For instance, the sensor component 1114 may detect an open/closed state of the apparatus 1100, relative positioning of components, e.g., the display and the keypad, of the apparatus 1100, a change in position of the apparatus 1100 or a component of the apparatus 1100, a presence or absence of user contact with the apparatus 1100, an orientation or an acceleration/deceleration of the apparatus 1100, and a change in temperature of the apparatus 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the apparatus 1100 and other devices. The apparatus 1100 may access a wireless network based on a communication standard, such as WiFi, 4G, or 5G, or a combination thereof. In an embodiment, the communication component 1116 receives a broadcast signal or broadcast associated information from an external broadcast management system via a broadcast channel. In an embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the apparatus 1100 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 1104 including instructions, the above instructions may be executed by the processor 1120 in the apparatus 1100 for performing the above-described methods. For example, the non-transitory computer-readable storage medium may be a ROM, a Random Access Memory (RAM), a CD-ROM, a magnetic tape, a floppy disc, an optical data storage device, and the like.

Based on the same concept as the above method embodiments, embodiments of the present disclosure further provide a communication device, which may have the functions of the network device 101 in the above method embodiments, and can be configured to perform steps performed by the network device 101 according to the above method embodiments. These functions may be implemented by hardware, or may be implemented by software or by hardware executing corresponding software. The hardware or software includes one or more modules corresponding to the above functions.

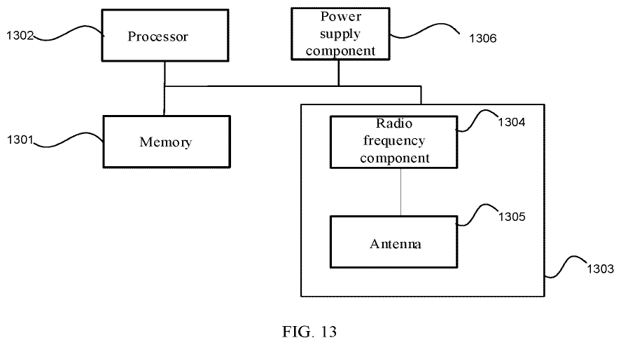

In an implementation, the communication device 1200 shown in FIG. 12 may serve as the network device 101 involved in the above method embodiments, and perform the steps performed by the network device 101 in the above method embodiments.

The communication device 1200 includes:
a transceiver module 1201, configured to receive a first capability for indicating support for inter-band carrier aggregation and first information for indicating coverage of an aggregated spectrum that are sent by a user equipment.

In some implementations, the transceiver module 1201 sends a first configuration to the user equipment, wherein the first configuration includes a carrier aggregation configuration limited by the coverage.

In some implementations, the transceiver module 1201 receives second information sent by the user equipment, wherein the second information is used to indicate a type of radio frequency link supporting multi-carrier aggregation.

In some implementations, in response to the type of radio frequency link supporting the multi-carrier aggregation being a first type, the transceiver module 1201 sends a second configuration to the user equipment, wherein the first type corresponds to a multi-link type, and the second configuration includes a carrier aggregation configuration that is not limited by the coverage.

In some possible embodiments, in response to the type of radio frequency link supporting the multi-carrier aggregation being a second type or a third type, the transceiver module 1201 receives a third configuration sent by the network device, wherein the second type corresponds to a single-link type, the third type corresponds to supporting both a first type and the second type, the first type corresponds to a multi-link type, and wherein the third configuration includes a carrier aggregation configuration limited by the coverage.

In some implementations, the transceiver module 1201 receives third information sent by the user equipment, wherein the third information is used to indicate whether a High Power Spectrum Density (PSD)-Difference Capability (HPC) between different carriers is supported.

In some implementations, the transceiver module 1201 receiving the third information sent by the user equipment includes:
receiving a first signaling sent by the user equipment to determine that the HPC is supported by the user equipment, or,
receiving a second signaling sent by the user equipment to determine that the HPC is not supported by the user equipment, wherein the first signaling is not included in the second signaling.

In some implementations, in response to the third information indicating that the High Power Spectrum Density (PSD)-Difference Capability (HPC) between different carriers is not supported, the transceiver module 1201 sends a fourth configuration to the user equipment, wherein the fourth configuration includes a carrier aggregation configuration limited by the coverage.

In some implementations, in response to the third information indicating that the High Power Spectrum Density (PSD)-Difference Capability (HPC) between different carriers is supported, the transceiver module 1201 sends a fifth configuration to the user equipment, wherein the fifth configuration includes a carrier aggregation configuration that is not limited by the coverage.

In some implementations, the network device is applied to a multi-carrier system, wherein the multi-carrier system includes Carrier Aggregation (CA) and Dual Connectivity (DC), and the dual connectivity is one of: NR DC, EN-DC, NE-DC, or NGNE-DC.

When the communication device is the network device, its structure may also be as shown in FIG. 13. The configuration of the communication device will be described by taking the network device 101 as a base station as an example. As shown in FIG. 13, the apparatus 1300 includes a memory 1301, a processor 1302, a transceiver component 1303, and a power supply component 1306. The memory 1301 is coupled with the processor 1302, and may be configured to store programs and data necessary for the communication device 1300 to realize various functions. The processor 1302 is configured to support the communication device 1300 to perform the corresponding functions in the above-mentioned methods, and the functions can be implemented by invoking programs stored in the memory 1301. The transceiver component 1303 may be a wireless transceiver, and may be configured to support the communication device 1300 to receive signaling and/or data, and to transmit signaling and/or data through a wireless air interface. The transceiver component 1303 may also be referred to as a transceiver unit or a communication unit, and the transceiver component 1303 may include a radio frequency component 1304 and one or more antennas 1305. The radio frequency component 1304 may be a remote radio unit (RRU), and may be specifically used for the transmission of radio frequency signals and conversion between radio frequency signals and baseband signals. The one or more antennas 405 may be specifically used for radiation and reception of radio frequency signals.

When the communication device 1300 needs to send data, the processor 1302 may carry out baseband processing on the data to be sent, and output the baseband signal to the radio frequency unit. The radio frequency unit carries out the radio frequency processing on the baseband signal and sends the radio frequency signal through the antenna in the form of electromagnetic waves. When data is sent to the communication device 1300, the radio frequency unit receives the radio frequency signal through the antenna, converts the radio frequency signal into the baseband signal, and outputs the baseband signal to the processor 1302. Then the processor 1302 converts the baseband signal into data and process the data.

The present disclosure provides a method and apparatus for transmitting a terminal capability, and a readable storage medium.

In a first aspect, there is provided a method for transmitting a terminal capability, which is performed by a user equipment. The method includes:

sending, to a network device, a first capability for indicating support for inter-band carrier aggregation and first information for indicating coverage of an aggregated spectrum.

In this method, the user equipment sends to the network device the first information for indicating the coverage of the aggregated spectrum, so that the network device is clearly aware of the coverage of the aggregated spectrum that the user equipment can support, providing a condition for the network device to set a carrier aggregation configuration for the user equipment that meets a capability of the user equipment, so as to prevent the carrier aggregation connection failure.

In some implementations, the sending, to the network device, the first capability for indicating the support for the inter-band carrier aggregation and the first information for indicating the coverage of the aggregated spectrum includes:
simultaneously sending, to the network device, the first capability for indicating the support for the inter-band carrier aggregation and the first information for indicating the coverage of the aggregated spectrum.

In some implementations, the method further includes:
receiving a first configuration sent by the network device, wherein the first configuration includes a carrier aggregation configuration limited by the coverage.

In some implementations, the method further includes:
sending second information to the network device, wherein the second information is used to indicate a type of radio frequency link supporting multi-carrier aggregation.

In some implementations, the type of radio frequency link supporting the multi-carrier aggregation is a first type, and the first type corresponds to a multi-link type.

In some implementations, the method further includes:
receiving a second configuration sent by the network device, wherein the second configuration includes a carrier aggregation configuration that is not limited by the coverage.

In some implementations, the type of radio frequency link supporting the multi-carrier aggregation is a second type, and the second type corresponds to a single-link type.

In some implementations, the type of radio frequency link supporting the multi-carrier aggregation is a third type, the third type corresponds to supporting both a first type and a second type, the first type corresponds to a multi-link type, and the second type corresponds to a single-link type.

In some implementations, the method further includes:
receiving a third configuration sent by the network device, wherein the third configuration includes a carrier aggregation configuration limited by the coverage.

In some implementations, the method further includes:
sending third information to the network device, wherein the third information is used to indicate whether a High Power Spectrum Density (PSD)-Difference Capability (HPC) between different carriers is supported.

In some implementations, the sending the third information to the network device includes:
sending a first signaling to the network device, wherein the first signaling corresponds to indicating support, or,
sending a second signaling to the network device, wherein the second signaling corresponds to indicating non-support, and the first signaling is not included in the second signaling.

In some implementations, the method further includes:
in response to the third information being used to indicate that the High Power Spectrum Density (PSD)-Difference Capability (HPC) between different carriers is not supported, receiving a fourth configuration sent by the network device, wherein the fourth configuration includes a carrier aggregation configuration limited by the coverage.

In some implementations, the method further includes:
in response to the third information being used to indicate that the High Power Spectrum Density (PSD)-Difference Capability (HPC) between different carriers is supported, receiving a fifth configuration sent by the network device, wherein the fifth configuration includes a carrier aggregation configuration that is not limited by the coverage.

In some implementations, the user equipment is applied to a multi-carrier system, wherein the multi-carrier system includes Carrier Aggregation (CA) and Dual Connectivity (DC), and the dual connectivity is one of: NR DC, EN-DC, NE-DC, or NGNE-DC.

In a second aspect, there is provided a method for receiving a terminal capability, which is performed by a network device. The method includes:
receiving a first capability for indicating support for inter-band carrier aggregation and first information for indicating coverage of an aggregated spectrum that are sent by a user equipment.

In this method, the network device receives the first information for indicating the coverage of the aggregated spectrum that are sent by the user equipment, so as to clearly be aware of the coverage of the aggregated spectrum that the user equipment can support, and set a carrier aggregation configuration for the user equipment that meets a capability of the user equipment, preventing the carrier aggregation connection failure.

In some implementations, the method further includes:
sending a first configuration to the user equipment, wherein the first configuration includes a carrier aggregation configuration limited by the coverage.

In some implementations, the method further includes:
receiving second information sent by the user equipment, wherein the second information is used to indicate a type of radio frequency link supporting multi-carrier aggregation.

In some implementations, the method further includes:
in response to the type of radio frequency link supporting the multi-carrier aggregation being a first type, sending a second configuration to the user equipment, wherein the first type corresponds to a multi-link type, and the second configuration includes a carrier aggregation configuration that is not limited by the coverage.

In some implementations, the method further includes:

in response to the type of radio frequency link supporting the multi-carrier aggregation being a second type or a third type, sending a third configuration to the user equipment, wherein the second type corresponds to a single-link type, the third type corresponds to supporting both a first type and the second type, the first type corresponds to a multi-link type, and wherein the third configuration includes a carrier aggregation configuration limited by the coverage.

In some implementations, the method further includes:
receiving third information sent by the user equipment, wherein the third information is used to indicate whether a High Power Spectrum Density (PSD)-Difference Capability (HPC) between different carriers is supported.

In some implementations, the receiving the third information sent by the user equipment includes:
receiving a first signaling sent by the user equipment to determine that the HPC is supported by the user equipment, or,
receiving a second signaling sent by the user equipment to determine that the HPC is not supported by the user equipment, wherein the first signaling is not included in the second signaling.

In some implementations, the method further includes:
in response to the third information indicating that the High Power Spectrum Density (PSD)-Difference Capability (HPC) between different carriers is not supported, sending a fourth configuration to the user equipment, wherein the fourth configuration includes a carrier aggregation configuration limited by the coverage.

In some implementations, the method further includes:

in response to the third information indicating that the High Power Spectrum Density (PSD)-Difference Capability (HPC) between different carriers is supported, sending a fifth configuration to the user equipment, wherein the fifth configuration includes a carrier aggregation configuration that is not limited by the coverage.

In some implementations, the network device is applied to a multi-carrier system, wherein the multi-carrier system includes Carrier Aggregation (CA) and Dual Connectivity (DC), and the dual connectivity is one of: NR DC, EN-DC, NE-DC, or NGNE-DC.

According to a third aspect, there is provided an apparatus for sending a terminal capability, which is configured in a user equipment. The apparatus includes:
a transceiver module, configured to send, to a network device, a first capability for indicating support for inter-band carrier aggregation and first information for indicating coverage of an aggregated spectrum.

In some implementations, the transceiver module is further configured to simultaneously send, to the network device, the first capability for indicating the support for the inter-band carrier aggregation and the first information for indicating the coverage of the aggregated spectrum.

In some implementations, the transceiver module is further configured to receive a first configuration sent by the network device, wherein the first configuration includes a carrier aggregation configuration limited by the coverage.

In some implementations, the transceiver module is further configured to send second information to the network device, wherein the second information is used to indicate a type of radio frequency link supporting multi-carrier aggregation.

In some implementations, the type of radio frequency link supporting the multi-carrier aggregation is a first type, and the first type corresponds to a multi-link type.

In some implementations, the transceiver module is further configured to receive a second configuration sent by the network device, wherein the second configuration includes a carrier aggregation configuration that is not limited by the coverage.

In some implementations, the type of radio frequency link supporting the multi-carrier aggregation is a second type, and the second type corresponds to a single-link type.

In some implementations, the type of radio frequency link supporting the multi-carrier aggregation is a third type, the third type corresponds to supporting both a first type and a second type, the first type corresponds to a multi-link type, and the second type corresponds to a single-link type.

In some implementations, the transceiver module is further configured to receive a third configuration sent by the network device, wherein the third configuration includes a carrier aggregation configuration limited by the coverage.

In some implementations, the transceiver module is further configured to send third information to the network device, wherein the third information is used to indicate whether a High Power Spectrum Density (PSD)-Difference Capability (HPC) between different carriers is supported.

In some implementations, the transceiver module is further configured to send a first signaling to the network device, wherein the first signaling corresponds to indicating support, or, send a second signaling to the network device, wherein the second signaling corresponds to indicating non-support, and the first signaling is not included in the second signaling.

In some implementations, the transceiver module is further configured to, in response to the third information indicating that the High Power Spectrum Density (PSD)-Difference Capability (HPC) between different carriers is not supported, receive a fourth configuration sent by the network device, wherein the fourth configuration includes a carrier aggregation configuration limited by the coverage.

In some implementations, the transceiver module is further configured to, in response to the third information indicating that the High Power Spectrum Density (PSD)-Difference Capability (HPC) between different carriers is supported, receive a fifth configuration sent by the network device, wherein the fifth configuration includes a carrier aggregation configuration that is not limited by the coverage.

In some implementations, the user equipment is applied to a multi-carrier system, wherein the multi-carrier system includes Carrier Aggregation (CA) and Dual Connectivity (DC), and the dual connectivity is one of: NR DC, EN-DC, NE-DC, or NGNE-DC.

In a fourth aspect, there is provided an apparatus for receiving a terminal capability, which is configured in a network device, and the apparatus may be configured to perform steps performed by the network device in the second aspect or any possible design thereof. The network device may implement each function in the above-mentioned methods in the form of a hardware structure, a software module, or a combination of hardware structure and software module.

When the communication device shown in the second aspect is implemented by the software module, the communication device may include a transceiver module.

The transceiver module is configured to receive a first capability for indicating support for inter-band carrier aggregation and first information for indicating coverage of an aggregated spectrum that are sent by a user equipment.

In a fifth aspect, there is provided a communication device, including a processor and a memory; the memory is configured to store a computer program; and the processor is configured to perform the computer program to implement the first aspect or any possible design thereof.

In a sixth aspect, there is provided a communication device, including a processor and a memory; the memory is configured to store a computer program; the processor is configured to perform the computer program to implement the second aspect or any possible design thereof.

In a seventh aspect, there is provided a computer-readable storage medium, with instructions (or computer programs, programs) being stored thereon, which, when invoked and executed on a computer, cause the computer to implement the first aspect or any possible design thereof.

In an eighth aspect, there is provided a computer-readable storage medium, with instructions (or computer programs, programs) being stored thereon, which, when invoked and executed on a computer, cause the computer to implement the second aspect or any possible design thereof.

Other implementations of the disclosed embodiments will readily occur to those skilled in the art upon consideration of the specification and practice of the present disclosure. The present disclosure is intended to cover any variations, uses, or adaptations of the disclosed embodiments that follow the general principles of the disclosed embodiments and include common general knowledge or conventional technical means in the art not disclosed in the present disclosure. The specification and examples are to be regarded as exemplary only, with the actual scope and spirit of embodiments of the present disclosure being indicated by the following claims.

It should be understood that some embodiments of the present disclosure are not limited to the precise structures described above and illustrated in the accompanying drawings, and that various modifications and changes may be made without departing from the scope thereof. The scope of embodiments of the present disclosure is limited only by the appended claims.

### INDUSTRIAL APPLICABILITY

The user equipment sends to the network device the first information for indicating the coverage of the aggregated spectrum, so that the network device is clearly aware of the coverage of the aggregated spectrum that the user equipment can support, providing a condition for the network device to set a carrier aggregation configuration for the user equipment that meets a capability of the user equipment, so as to prevent the carrier aggregation connection failure.

1. A method for sending a terminal capability, performed by a user equipment, and comprising:
sending, to a network device, a first capability for indicating support for inter-band carrier aggregation and first information for indicating coverage of an aggregated spectrum.

2. The method according to claim 1, wherein the sending, to the network device, the first capability for indicating the support for the inter-band carrier aggregation and the first information for indicating the coverage of the aggregated spectrum comprises:
simultaneously sending, to the network device, the first capability for indicating the support for the inter-band carrier aggregation and the first information for indicating the coverage of the aggregated spectrum.

3. The method according to claim 1- or 2, wherein the method further comprises:
receiving a first configuration sent by the network device, wherein the first configuration comprises a carrier aggregation configuration limited by the coverage.

4. The method according to claim 1, wherein the method further comprises:
sending second information to the network device, wherein the second information is used to indicate a type of radio frequency link supporting multi-carrier aggregation.

5. The method according to claim 4, wherein the type of radio frequency link supporting the multi-carrier aggregation is a first type, and the first type corresponds to a multi-link type, and
the method further comprises receiving a second configuration sent by the network device, wherein the second configuration comprises a carrier aggregation configuration that is not limited by the coverage.

6. (canceled)

7. The method according to claim 4, wherein the type of radio frequency link supporting the multi-carrier aggregation is a second type, and the second type corresponds to a single-link type, or
the type of radio frequency link supporting the multi-carrier aggregation is a third type, the third type corresponds to supporting both a first type and the second type, the first type corresponds to a multi-link type, and the second type corresponds to the single-link type.

8. (canceled)

9. The method according to claim 7, wherein the method further comprises:
receiving a third configuration sent by the network device, wherein the third configuration comprises a carrier aggregation configuration limited by the coverage.

10. The method according to claim 1, wherein the method further comprises:
sending third information to the network device, wherein the third information is used to indicate whether a High Power Spectrum Density (PSD)-Difference Capability (HPC) between different carriers is supported.

11. The method according to claim 10, wherein the sending the third information to the network device comprises:
sending a first signaling to the network device, wherein the first signaling corresponds to indicating support, or,
sending a second signaling to the network device, wherein the second signaling corresponds to indicating non-support, and the first signaling is not comprised in the second signaling.

12. The method according to claim 10, wherein the method further comprises:
in response to the third information indicating that the High Power Spectrum Density (PSD)-Difference Capability (HPC) between different carriers is not supported, receiving a fourth configuration sent by the network device, wherein the fourth configuration comprises a carrier aggregation configuration limited by the coverage; or
in response to the third information indicating that the High Power Spectrum Density (PSD)-Difference Capability (HPC) between different carriers is supported, receiving a fifth configuration sent by the network device, wherein the fifth configuration comprises a carrier aggregation configuration that is not limited by the coverage.

13. (canceled)

14. The method according to claim 1, wherein the user equipment is applied to a multi-carrier system, wherein the multi-carrier system comprises Carrier Aggregation (CA) and Dual Connectivity (DC), and the dual connectivity is one of: NR DC, EN-DC, NE-DC, or NGNE-DC.

15. A method for receiving a terminal capability, performed by a network device, and comprising:
receiving a first capability for indicating support for inter-band carrier aggregation and first information for indicating coverage of an aggregated spectrum that are sent by a user equipment.

16. The method according to claim 15, wherein the method further comprises:
sending a first configuration to the user equipment, wherein the first configuration comprises a carrier aggregation configuration limited by the coverage.

17. The method according to claim 15- or 16, wherein the method further comprises:
receiving second information sent by the user equipment, wherein the second information is used to indicate a type of radio frequency link supporting multi-carrier aggregation.

18. The method according to claim 17, wherein the method further comprises:
in response to the type of radio frequency link supporting the multi-carrier aggregation being a first type, sending a second configuration to the user equipment, wherein the first type corresponds to a multi-link type, and the second configuration comprises a carrier aggregation configuration that is not limited by the coverage; or
in response to the type of radio frequency link supporting the multi-carrier aggregation being a second type or a third type, sending a third configuration to the user equipment, wherein the second type corresponds to a single-link type, the third type corresponds to supporting both a first type and the second type, the first type corresponds to a multi-link type, and the third configuration comprises a carrier aggregation configuration limited by the coverage.

19. (canceled)

20. The method according to claim 15, wherein the method further comprises:
receiving third information sent by the user equipment, wherein the third information is used to indicate whether a High Power Spectrum Density (PSD)-Difference Capability (HPC) between different carriers is supported,
wherein the receiving the third information sent by the user equipment comprises:
receiving a first signaling sent by the user equipment to determine that the HPC is supported by the user equipment, or
receiving a second signaling sent by the user equipment to determine that the HPC is not supported by the user equipment, wherein the first signaling is not comprised in the second signaling.

21. (canceled)

22. The method according to claim 20, wherein the method further comprises:
in response to the third information indicating that the High Power Spectrum Density (PSD)-Difference Capability (HPC) between different carriers is not supported, sending a fourth configuration to the user equipment, wherein the fourth configuration comprises a carrier aggregation configuration limited by the coverage; or
in response to the third information indicating that the High Power Spectrum Density (PSD)-Difference Capability (HPC) between different carriers is supported, sending a fifth configuration to the user equipment, wherein the fifth configuration comprises a carrier aggregation configuration that is not limited by the coverage.

23. (canceled)

24. The method according to claim 15, wherein the network device is applied to a multi-carrier system, wherein the multi-carrier system comprises Carrier Aggregation (CA) and Dual Connectivity (DC), and the dual connectivity is one of: NR DC, EN-DC, NE-DC, or NGNE-DC.

25-39. (canceled)

40. A communication device, comprising:
a processor; and
a memory storing instructions executable by the processor,
wherein the processor is configured to:
send, to a network device, a first capability for indicating support for inter-band carrier aggregation and first information for indicating coverage of an aggregated spectrum.

41. A communication device, comprising:
a processor; and
a memory storing instructions executable by the processor,
wherein the processor is configured to perform the method according to claim 15.

42-43. (canceled)
